(19) United States
(12) Patent Application Publication
(10) Pub. No.: US 2023/0194723 A1
(43) Pub. Date: Jun. 22, 2023

(54) HEAT INSULATION PIZZA BOX

(71) Applicant: GENICOOK PRODUCT, LLC, GARLAND, TX (US)

(72) Inventors: Jianzhong Zhang, Handan (CN); Jiehao Yan, Handan (CN)

(73) Assignee: GENICOOK PRODUCT, LLC, GARLAND, TX (US)

(21) Appl. No.: 18/108,687

(22) Filed: Feb. 13, 2023

(30) Foreign Application Priority Data
Jan. 10, 2023 (CN) 202320070573.6

(51) Int. Cl. G01S 17/89; G01S 7/481; G01S 17/48; G03B 9/28; G03B 15/06

(52) U.S. Cl. CPC G01S 17/89; G01S 7/4813; G01S 7/4817; G01S 17/48; G03B 9/28; G03B 15/06

(57) ABSTRACT

The present invention discloses a laser radar for synchronous scanning of line exposure and point lasers of a rolling shutter door and a detection method. The laser radar comprises: a point light source rotating mechanism and an image sensor mechanism; the rotation speed of the point light source rotating mechanism is consistent with the scanning speed of the image sensor mechanism, and the phase is synchronized; and a region illuminated by lasers is in the region corresponding to the exposure line of the rolling shutter door of the image sensor mechanism. The present invention proposes the use of point laser rotating scanning in combination with line scanning of the rolling shutter door to synchronously realize the functions of line lasers.

### TECHNICAL FIELD

The present invention relates to the technical field of laser radars, and particularly relates to a laser radar for synchronous scanning of line exposure and point lasers of a rolling shutter door and a detection method.

### BACKGROUND

The existing ranging schemes in the market include triangulation ranging and time-of-flight ranging. The laser radar based on triangulation ranging has been widely used. The common triangulation ranging in the market includes structured light ranging, line laser ranging and LDS laser ranging radar for sweeping robots which are small and slow and have low accuracy.

Line lasers are mainly used in parts testing of industrial products, contour recognition of small objects and scanning of terrain environment. The unevenness degree of a scanned plane can be obtained by different measured distances to judge whether a part has defects; and in the field of industrial robots, the surrounding environment also can be scanned to obtain terrain information, and small objects can be recognized to obtain contour information (for the robot scene, including terrain recognition and small object recognition).

The single point laser of an LDS radar is mainly used in civil laser ranging products, for example, a domestic sweeping robot obtains a 2D map of the surrounding environment through the rotation of the point laser and triangulation ranging.

However, line lasers do not meet civil standards due to the need for high instantaneous laser power; and the single point laser of the LDS radar cannot meet the urgent demand of the market for civil laser ranging products because of poor angular accuracy and high angular resolution.

In terms of point lasers and line lasers:

(1) An LDS ranging radar based on point laser scanning uses a single point laser and a sensor to realize single point ranging through triangulation ranging, and then implements a ranging scheme with a maximum of 360° through a rotating mechanism. The basic principle of triangulation ranging of point lasers is that a semiconductor laser emits one or more lasers at a certain angle to irradiate the measured object, the reflected light is focused by a lens and imaged on a CCD, and the actual distance of the object is calculated according to the imaging position of the spot and the geometric relationship between the laser and the CCD. In addition, the point laser radar has poor angular accuracy and only can be used for one-line measurement. The traditional LDS radars, sensors and lasers are all on the rotating component, thus requiring higher rotary power, and requiring higher facility cost to transmit electricity and signals.

(2) A line laser radar can use a single line laser and an image sensor to obtain depth data on a straight line through triangulation ranging. The line laser radar has very high test precision in close range tests because of high camera resolution and long baseline. Linear laser triangulation ranging is mainly that a line laser is irradiated on the measured object at a certain incident angle, the reflected light is focused by a lens and imaged on a CCD, and the actual distance of the object is calculated according to the imaging position of the linear laser beam. In addition, the linear laser radar cannot meet the requirements of laser safety due to the need for high instantaneous laser power to test distant objects, only can be used for short ranges, and has to use an expensive globalshutter sensor, so the linear laser radar cannot be popularized.

Civil line laser scanning equipment with high requirements for precision need safe low-power lasers and rapid and accurate measurement results, and the two conditions cannot be realized at present. Therefore, the contradiction between high-frequency and high-precision line laser ranging and safe output power is an urgent problem for practitioners in this field.

### SUMMARY

The purpose of the present invention is to provide a laser radar for synchronous scanning of line exposure and point lasers of a rolling shutter door and a detection method, which solves the problem that the existing line laser products may cause harm to human eyes due to overhigh laser power and only can be used for one-line scanning due to poor precision of the LDS radar.

To achieve the above purpose, the present invention adopts the following technical solution:

In the first aspect, embodiments of the present invention provide a laser radar for synchronous scanning of line exposure and point lasers of a rolling shutter door, comprising: a point light source rotating mechanism and an image sensor mechanism;

The rotation speed of the point light source rotating mechanism is consistent with the scanning speed of the image sensor mechanism, the phase is synchronized, and a region illuminated by lasers is in the region corresponding to the exposure line of the rolling shutter door of the image sensor mechanism.

Further, the point light source rotating mechanism comprises a rotating motor with an encoder, a rotating disk, and one or a plurality of point lasers;

When one point laser is used, the laser is arranged at a preset distance from the image sensor mechanism, and the scanning direction is consistent; and when a plurality of point lasers are used, the point lasers are arranged along the rotating disk in the circumferential direction;

The rotating motor with an encoder drives the rotating disk to rotate and then drives the point laser to rotate;

The rotation speed of the point laser is consistent with the scanning speed of the image sensor mechanism, the phase is synchronized, and a region illuminated by lasers is in the region corresponding to the exposure line of the rolling shutter door of the image sensor mechanism.

Further, the image sensor mechanism comprises one or a plurality of cameras;

When a plurality of cameras are used, the cameras are arranged along the extension line of the rotating shaft in the circumferential direction; and when one camera is used, the line scanning direction of the camera is consistent with the laser scanning direction of the point light source rotating mechanism, and the camera is arranged at a preset distance from the point light source rotating mechanism.

Further, the image sensor mechanism is composed of a binocular camera.

Further, the rotating disk comprises an upper rotating disk and a lower rotating disk; and the upper rotating disk and the lower rotating disk are respectively provided with an equal number of point lasers which are arranged along the respective rotating disk in the circumferential direction and in the positions corresponding vertically.

The upper rotating disk and the lower rotating disk rotate in the opposite directions so that the scanning direction of the laser mounted on the point light source rotating mechanism is corresponding to the exposure line projected by laser spots;

The image sensor mechanism is composed of a plurality of cameras or one wide-angle camera; and when the image sensor mechanism is composed of a plurality of cameras, the cameras are arranged along the extension line of the rotating shaft in the circumferential direction;

The upper rotating disk and the lower rotating disk rotate in the opposite directions to drive the point laser to rotate into a line shape and corresponding to the top-down exposure sequence of the rolling shutter door.

Further, the point light source rotating mechanism comprises: one rotational structure or two rotational structures;

Each rotational structure comprises a rotating motor with an encoder, a rotating disk, a point laser and a reflector assembly;

The reflector assembly is arranged on the rotating disk; the rotating motor with an encoder drives the rotating disk to rotate and then drives the reflector assembly to rotate; and emergent lasers of the point laser are incident on the reflector assembly;

When the reflector assembly rotates, the rotation speed of the emergent lasers is ensured to be consistent with the scanning speed of the image sensor mechanism, and a region illuminated by lasers is in the region corresponding to the exposure line of the rolling shutter door of the image sensor mechanism;

When the point light source rotating mechanism comprises two rotational structures, the two rotational structures are arranged up and down along the same rotating shaft; in the first rotational structure and the second rotational structure, the respective rotating disks rotate in the opposite directions, and the respective reflector assemblies are arranged in the opposite positions.

Further, the reflector assembly comprises a triangular reflector and a semi-transparent and semi-reflective mirror;

Emergent lasers of the point laser are incident on the triangular reflector, and then are reflected into the semi-transparent and semi-reflective mirror and split into two light beams: one beam is transmitted light, and the other beam is reflected light;

The initial positions of the two light beams are hit on a field of view (FOV) corresponding to the pixel of the first line of the image sensor mechanism, and the rotating motor drives the reflector assembly to rotate so that the rotation speed of the two light beams is consistent with the line scanning speed of the image sensor mechanism, so as to realize that the lasers are always irradiated on the FOV corresponding to the exposure line of the image sensor mechanism.

Further, the reflector assembly comprises two reflectors combined together;

Emergent lasers of the point laser are incident on the intersection of the two reflectors, and split into two light beams: one beam is upper reflected light, and the other beam is lower reflected light; and the intersection is on the rotating shaft;

The initial positions of the two light beams are hit on a field of view (FOV) corresponding to the pixel of the first line of the image sensor mechanism, and the rotating motor drives the reflector assembly to rotate so that the rotation speed of the two light beams is consistent with the line scanning speed of the image sensor mechanism, so as to realize that the lasers are always irradiated on the FOV corresponding to the exposure line of the image sensor mechanism.

Further, the point light source rotating mechanism comprises a rotating motor with an encoder, a rotating disk, a point laser source and a multi-faced prismatic reflector;

When the point laser source is composed of one point laser, the laser is arranged at a preset distance from the image sensor mechanism, and the scanning direction is consistent; and when the point laser source is composed of a plurality of point lasers, the point lasers are arranged along the extension line of the rotating shaft in the circumferential direction;

The multi-faced prismatic reflector is arranged on the rotating disk; the rotating motor with an encoder drives the rotating disk to rotate and then drives the multi-faced prismatic reflector to rotate; and when the multi-faced prismatic reflector rotates, the direction of light emission will change due to the change of the included angle between the reflecting surface and the lasers, thus obtaining multiple reflected lasers with different angles of light emission;

The rotation speed of the multiple alternating reflected lasers is consistent with the scanning speed of the image sensor mechanism, and a region illuminated by lasers is in the region corresponding to the exposure line of the rolling shutter door of the image sensor mechanism;

In the second aspect, the present invention also provides a detection method for a laser radar for synchronous scanning of line exposure and point lasers of a rolling shutter door, which uses the laser radar for synchronous scanning of line exposure and point lasers of a rolling shutter door of the above embodiments to realize ranging of a target object. The method comprises:

(1) Controlling the rotation speed of the point light source rotating mechanism to be consistent with the scanning speed of the image sensor mechanism and the phase to be synchronized, and keeping a region illuminated by lasers in the region corresponding to the exposure line of the rolling shutter door of the image sensor mechanism;

(2) According to the emission angle and baseline distance of lasers in the point light source rotating mechanism, obtaining the distance from the target object by triangulation ranging after scanning with the image sensor mechanism.

Compared with the prior art, the present invention has the following beneficial effects:

The laser radar for synchronous scanning of line exposure and point lasers of a rolling shutter door provided by the embodiments of the present invention comprises: a point light source rotating mechanism and an image sensor mechanism; and the rotation speed of the point light source rotating mechanism is consistent with the scanning speed of the image sensor mechanism, the phase is synchronized, and a region illuminated by lasers is in the region corresponding to the exposure line of the rolling shutter door of the image sensor mechanism. The present invention proposes the use of point laser rotating scanning in combination with line scanning of the rolling shutter door to synchronously realize the functions of line lasers. A laser point is scanned as a laser line in space by the rotation of the point light source rotating mechanism, and the rotation of the laser point is synchronized with the frame rate of the image sensor mechanism, which enables low-power point lasers to achieve the effect of line lasers so as to be applied in civil equipment.

### DESCRIPTION OF DRAWINGS

FIG. 1 is a schematic diagram of structure and rotary scanning of a laser radar for synchronous scanning of line exposure and point lasers of a rolling shutter door provided by embodiments of the present invention;

FIG. 2 is a structural diagram of a line exposure camera of a rolling shutter door;

FIG. 3 is a schematic diagram of synchronizing signal output by the frame rate of a camera;

FIG. 4 is a schematic diagram of line laser testing with a rolling shutter door camera and a single laser source;

FIG. 5 is a schematic diagram of line laser testing with a rolling shutter door camera and a plurality of point laser sources;

FIG. 6a is a schematic diagram of line laser testing with a binocular camera and a single laser source;

FIG. 6b is a schematic diagram of distance calculation by triangulation ranging;

FIG. 7a is a structural schematic diagram of a laser radar with one camera in embodiment 1 of the present invention;

FIG. 7b is a structural schematic diagram of a laser radar with a plurality of cameras in embodiment 1 of the present invention;

FIG. 7c is a structural schematic diagram of a laser radar with a binocular camera in embodiment 1 of present invention;

FIG. 8 is a schematic diagram of a laser radar with two rotating disks and a super-wide-range camera in embodiment 2 of the present invention;

FIG. 9a is a structural schematic diagram of a laser radar with a triangular reflector assembly and one camera in embodiment 3 of the present invention;

FIG. 9b is a structural schematic diagram of a laser radar with a triangular reflector assembly and a plurality of cameras in embodiment 3 of the present invention;

FIG. 9c is a structural schematic diagram of a laser radar with two rotational structures and a super-wide-range camera in embodiment 3 of the present invention;

FIG. 9d is a structural schematic diagram of a laser radar with a binocular camera in embodiment 3 of present invention;

FIG. 10a is a structural schematic diagram of a laser radar with two reflectors combined together and one camera in embodiment 4 of the present invention;

FIG. 10b is a structural schematic diagram of a laser radar with two reflectors combined together and a plurality of cameras in embodiment 4 of the present invention;

FIG. 10c is a structural schematic diagram of a laser radar with two rotational structures and a super-wide-range camera in embodiment 4 of the present invention;

FIG. 10d is a structural schematic diagram of a laser radar with one rotational structure and a binocular camera in embodiment 4 of the present invention;

FIG. 11a is a schematic diagram of a laser radar with a point laser emitting on one bevel edge of a reflector in embodiment 5 of the present invention;

FIG. 11b is a schematic diagram of a laser radar with a point laser emitting on the other bevel edge of a reflector in embodiment 5 of the present invention;

FIG. 11c is a structural schematic diagram of a laser radar with a plurality of lasers and a plurality of cameras in embodiment 5 of the present invention;

FIG. 11d is a structural schematic diagram of a laser radar with one laser and a binocular camera in embodiment 5 of the present invention;

### DETAILED DESCRIPTION

To easily understand the technical means, the creative feature, the purpose and the effect realized by the present invention, the present invention is further elaborated below in combination with specific embodiments.

It should be indicated in the description of the present invention that terms such as “upper”, “lower”, “inner”, “outer”, “front”, “rear”, “both ends”, “one end”, “the other end” etc. indicate direction or position relationships shown based on the drawings, and are only intended to facilitate the description of the present invention and the simplification of the description rather than to indicate or imply that the indicated device or element must have a specific direction or constructed and operated in a specific direction, and therefore, shall not be understood as a limitation to the present invention. In addition, the terms such as “first” and “second” are only used for the purpose of description, rather than being understood to indicate or imply relative importance.

It should be noted in the description of the present invention that, unless otherwise specifically regulated and defined, terms such as “installation,” “provided with”, “connection”, etc. shall be understood in broad sense. For example, “connection” may refer to fixed connection or detachable connection or integral connection, may refer to mechanical connection or electrical connection, and may refer to direct connection or indirect connection through an intermediate medium or inner communication of two elements. For those ordinary skilled in the art, the specific meanings of the above terms in the present invention may be understood according to specific conditions.

A laser radar for synchronous scanning of line exposure and point lasers of a rolling shutter door provided by the present invention comprises: a point light source rotating mechanism and an image sensor mechanism;

The image sensor mechanism is located above or below the point light source rotating mechanism and used for receiving lasers reflected by a point light source; and the rotation speed of the point light source rotating mechanism is adjustable and consistent with the scanning speed of the image sensor mechanism, the phase is synchronized, and a region illuminated by lasers is in the region corresponding to the exposure line of the rolling shutter door of the image sensor mechanism.

The present invention proposes the use of point lasers to realize the functions of line lasers, which distributes laser points on a straight line through the rotation of the point light source rotating mechanism, for example, a photoelectric encoder is used to synchronize the emission of the laser and the frame reception of the image sensor so that a region illuminated by lasers is just in the region corresponding to the exposure line of the rolling shutter door of the image sensor mechanism. To achieve the effect of using low-power point lasers instead of line lasers without hurting human eyes, the integral structure is shown in FIG. 1. The following parts are included in concrete implementation: rotation of the point light source rotating mechanism, synchronous acquisition of the image sensor mechanism, synchronous control of the rotation of the light source and the frame rate of the image sensor mechanism, and distance calculation by triangulation ranging.

1) Rotation of the point light source rotating mechanism:

Can be the rotation of a laser point light source or the rotation of light realized by the rotation of the reflector assembly; and during the concrete implementation, the speed of the motor with an encoder is set to be adjustable, and the irradiation position and speed of lasers can be fed back to realize the synchronization of rotation of a point light source or emergent light with the exposure line of the image sensor mechanism.

2) Image sensor mechanism:

Is composed of one or a plurality of rolling shutter door line exposure cameras, or a wide-angle camera or a super-wide-range camera which has a larger field of view and covers a larger area than an ordinary camera;

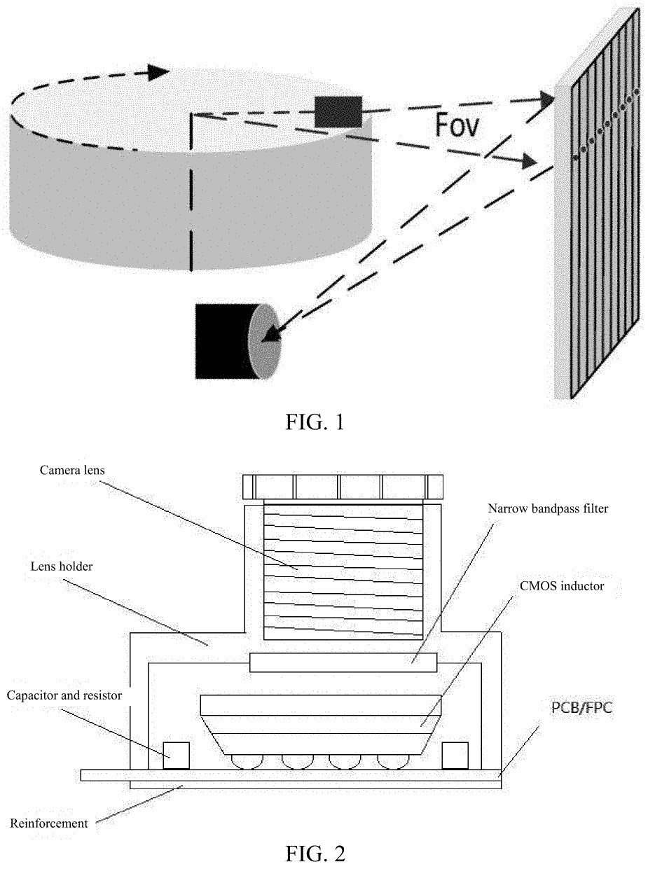

As shown in FIG. 2, an ordinary camera is composed of a camera lens, a lens holder, a narrow bandpass filter, a CMOS inductor, a PCB/FPC, a capacitor, a resistor and reinforcement.

One-line scanning and multi-line scanning are realized by synchronously controlling the rotation speed of the point light source rotating mechanism and the exposure time of the camera:

As shown in FIG. 3, the camera captures pictures at a fixed frame rate, and the frame rate of the camera synchronizes the signal output. The laser operates in the normally light mode. During the scanning process, the laser achieves distance measurement in different FOVs by adjusting the rotation speed and synchronizing the exposure time of the camera driver.

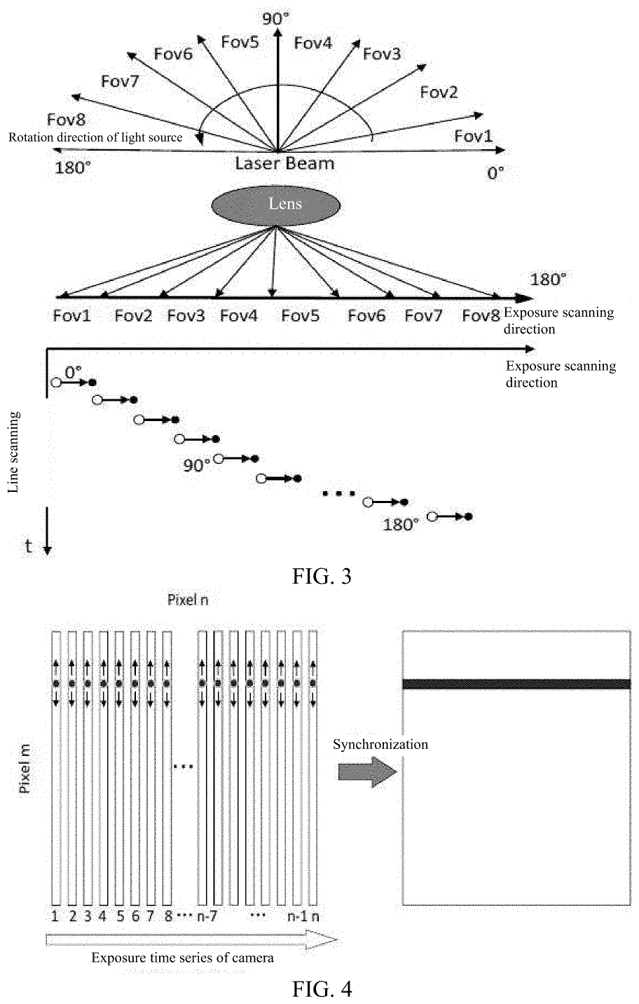

The camera has the single-frame image resolution of m columns and n lines of pixels and the frame rate of frate. By adjusting the rotation speed of the point light source rotating mechanism, the line scanning of the FOV and resolution of the camera is realized. According to the principle of triangulation ranging, when the distance of a reflecting object in front of the light source changes, the imaging position of the image point of the corresponding camera on the sensor changes accordingly. The high resolution scanning of a large FOV can be realized by combination of a plurality of cameras. The synchronization of the exposure direction of the camera with the point laser is shown in FIG. 4 The exposure direction can be adjusted to be consistent with the laser scanning direction by rotating the point light source or the emergent light.

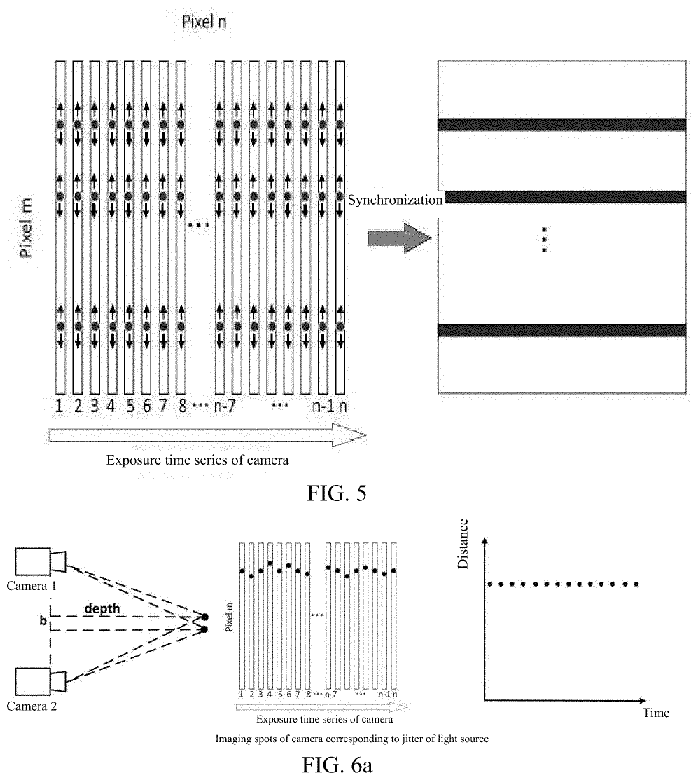

Multi-line scanning is realized by synchronous scanning of a plurality of point light sources, as shown in FIG. 5.

(1) The rotary scanning of the point light source rotating mechanism is controlled to be synchronized with the image acquisition of the camera so that when the first line of the camera is exposed, the spot of the laser is hit on the FOV corresponding to the pixel of the first line of the camera to scan the whole FOV successively.

(2) The rotation of the point light source rotating mechanism is controlled to be synchronized with the exposure of the camera to keep the rotation speed of the point light source rotating mechanism consistent with the line scanning speed of the camera.

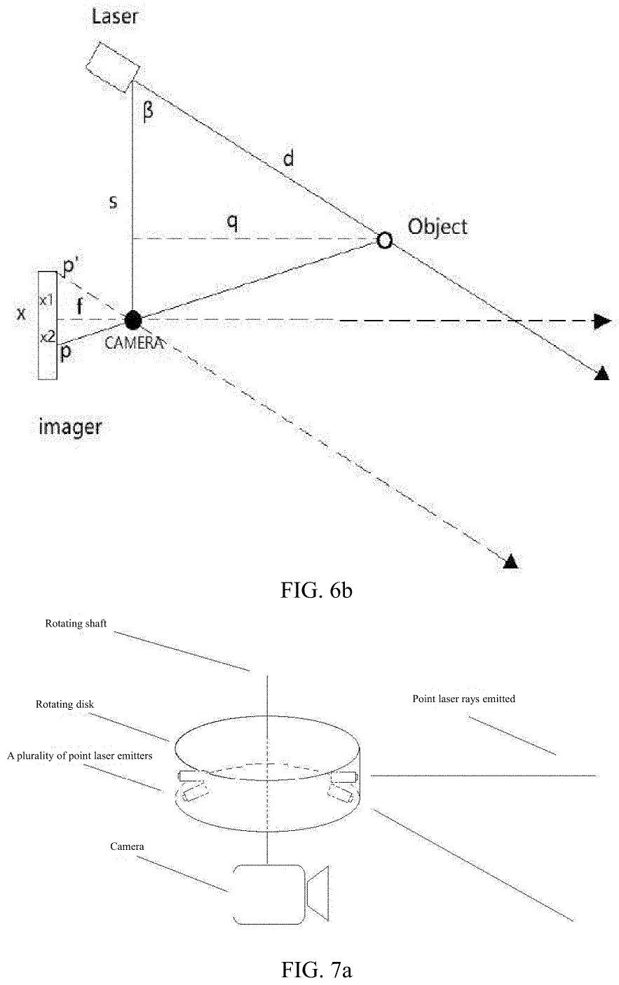

Further, the ordinary camera also can be a binocular camera; For example, the laser radar is rotated through a mechanical structure, and when the rotating shaft is loose, the position of the point light source will drift, and it is difficult to identify the distance change of the object or the spot position change caused by jitter of the point light source. Therefore, the binocular camera can be used to carry out distance testing synchronously with the laser of the point light source, which can effectively prevent the ranging error caused by rotation jitter of the laser; as shown in FIG. 6a, the specific process can be implemented in accordance with the binocular ranging principle in the prior art.

3) The triangulation ranging is adopted to calculate the distance:

As shown in FIG. 6b, the laser source and the camera are on the same vertical line (called the reference line), the distance is s, the focal length of the camera is f, and the included angle between the light source and the reference line is β.

Assuming that the position of the target object reflected back to the imaging plane of the camera under the irradiation of the point laser is a point P.

Based on the geometric knowledge, a similar triangle can be made, that is formed by the light source, the camera and the target object which are similar to the camera, the imaging point P and an auxiliary point P′.

Assuming PP′=x, q and d, as shown in FIG. 6, it can be obtained from the similar triangle that:

f/x=q/s→q=fs/x

Calculation can be divided into two parts:

x=x1+x2=f/tan β+pixelSize*position

wherein pixelSize is the size of a pixel unit, and position is the position of the imaging pixel coordinate relative to the imaging center. Finally, the distance can be obtained: d=q/sin β.

The structure of the laser radar for synchronous scanning of line exposure and point lasers of a rolling shutter door of the present invention is described below in combination with six more detailed embodiments:

### Embodiment 1

Rotation of laser point light source:

The point light source rotating mechanism comprises a rotating motor with an encoder, a rotating disk, and one or a plurality of point lasers; when one point laser is used, for example, the point laser can be arranged in the position of the rotating shaft on the rotating disk; when a plurality of point lasers are used, the point lasers are arranged at unequal intervals or uniformly along the rotating disk in the circumferential direction; the rotating motor with an encoder drives the rotating disk to rotate and then drives the point laser to rotate; and the rotation speed of the point laser is consistent with the scanning speed of the image sensor mechanism, the phase is synchronized, and a region illuminated by lasers is in the region corresponding to the exposure line of the rolling shutter door of the image sensor mechanism. In the embodiment of the present disclosure, the rotating motor with an encoder, the rotating disk and the driving relation are components available in the market, which will not be repeated here.

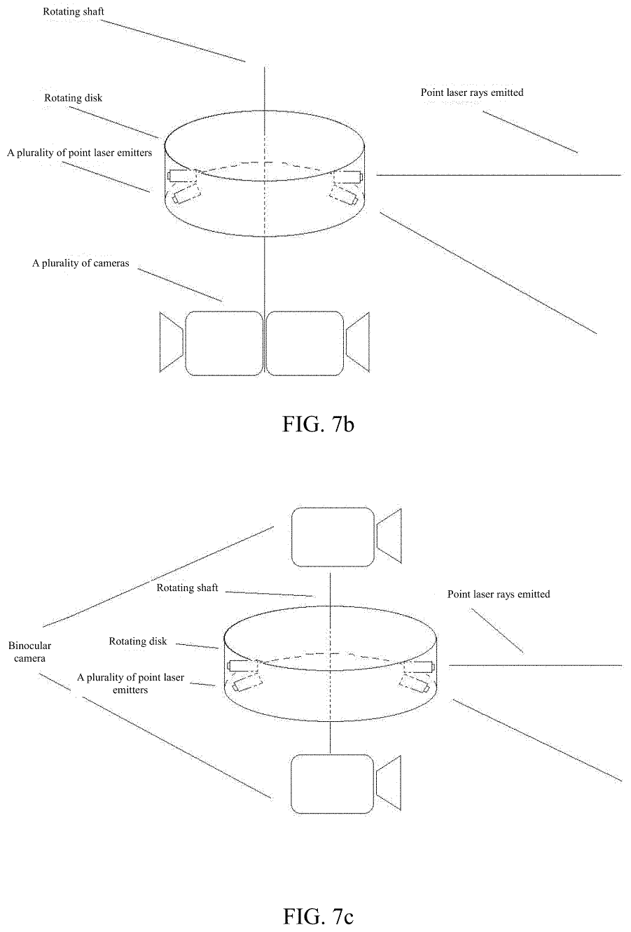

As shown in FIG. 7a and FIG. 7b, the image sensor mechanism comprises one or a plurality of cameras;

When one camera is used, the line scanning direction of the camera is consistent with the laser scanning direction, the camera is arranged at a certain distance from the laser, and the distance is related to measurement of the FOV viewing angle and ranging of the object; and when a plurality of cameras are used, the cameras are arranged along the extension line of the rotating shaft in the circumferential direction. In addition, as shown in FIG. 7c, the camera also can be a binocular camera, the binocular camera and the laser are used for synchronous scanning ranging, the camera is coaxial with the rotating shaft of the laser, and two lenses of the binocular camera can be arranged on both sides or one side of the laser for binocular ranging. Measurement of different FOVs and different angles can be realized by changing the number of the binocular cameras and the number of the laser. The stability of the system can be improved, the requirement for the precision of the system structure is lower than that for a monocular camera, and one-line and multi-line scanning ranging can be realized easily.

The working principle is as follows: the rotating disk rotates to drive the point laser to rotate so as to make the laser point scan circularly, wherein one or a plurality of cameras and lasers can be used, and measurement of different FOVs and different angles can be realized by changing the number of the cameras and the number of the lasers. When the camera starts to expose, the laser point is initially hit on the FOV corresponding to the pixel of the first line of the camera, and the rotation speed of the laser point is kept consistent with the line scanning speed of the camera to scan the whole FOV region. Because of different emission angles of the plurality of lasers in the rotating disk, the accurate distance value can be obtained by triangulation ranging according to the relative position after being scanned by the camera.

For example, if the laser radar is applied to an intelligent agent with a fixed motion track, then one camera and one laser can be used to meet the needs of ranging; and when the laser radar is applied to an intelligent agent (such as sweeping robot) without a planned path, a plurality of cameras and a plurality of lasers can be used to achieve accurate ranging of the surrounding objects. By using point lasers instead of line lasers, the laser power is greatly reduced, and the human eye safety level is improved while the price of the radar is reduced.

### Embodiment 2

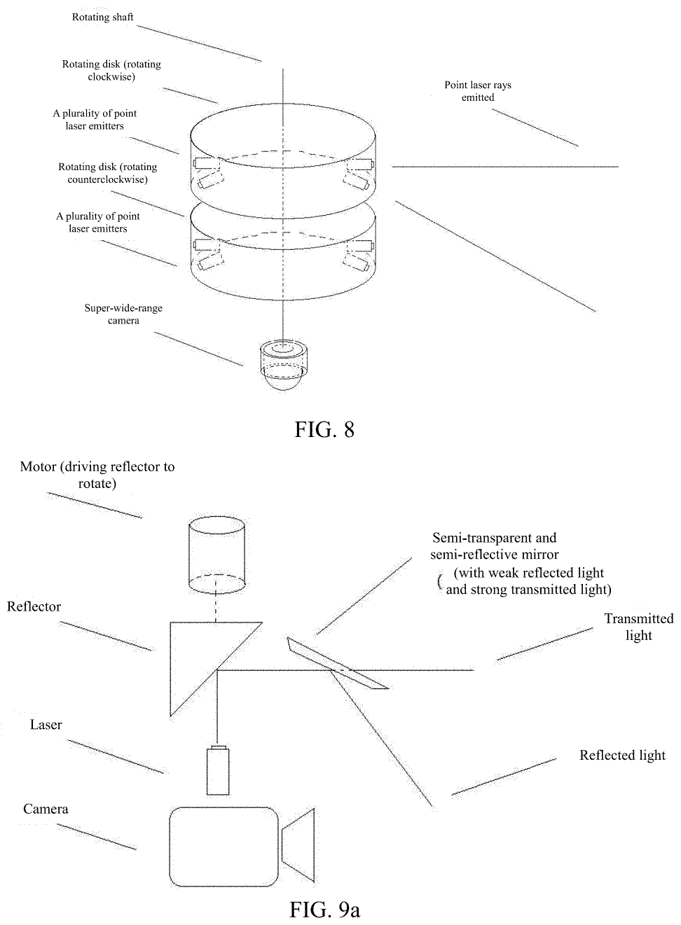

Also rotation of laser point light source, which is the same as embodiment 1. As shown in FIG. 8, it is different from embodiment 1 in that the rotating disk comprises an upper rotating disk and a lower rotating disk; the upper rotating disk and the lower rotating disk are respectively provided with an equal number of point lasers which are uniformly arranged along the respective rotating disk in the circumferential direction and in the positions corresponding vertically; the upper rotating disk rotates clockwise, and the lower rotating disk rotates counterclockwise; the image sensor mechanism is composed of a plurality of cameras or one wide-angle camera; when the image sensor mechanism is composed of a plurality of cameras, the cameras are uniformly arranged along the extension line of the rotating shaft in the circumferential direction; when the image sensor mechanism is composed of one wide-angle camera, the camera is arranged in the extension line of the rotating shaft; and the clockwise and counterclockwise rotating disks drive the point laser to rotate into a line shape and corresponding to the top-down exposure sequence of the rolling shutter door.

In the embodiment of the present disclosure, the rotating motor with an encoder, the two rotating disks rotating in different directions and the driving relation are components available in the market, which will not be repeated here.

The working principle is as follows: the upper rotating disk rotates clockwise, and the lower rotating disk rotates counterclockwise. The laser points of the two rotating disks are respectively scanned on the left and right sides of one line of a sensor. The rotating disk needs to scan at a variable speed so that the laser point is hit on the FOV region corresponding to the exposure line of the sensor. When the camera starts to expose, the laser point is hit on the FOV corresponding to the pixel of the first line of the camera, the rotation speed of the laser point is kept consistent with the line scanning speed of the camera, the phase is synchronized, and the clockwise and counterclockwise rotating disks drive the laser point to rotate into a line shape and corresponding to the top-down exposure sequence of the rolling shutter door. Because of different emission angles of the plurality of lasers in the rotating disk, the accurate distance value can be obtained by triangulation ranging according to the relative position after being scanned by the camera.

For example, a single fisheye lens can be used to achieve wide-angle ranging. In order to improve the test efficiency, in the embodiment, the two rotating disks are used to rotate counterclockwise and clockwise respectively, so as to achieve the ranging information of multiple lasers at different angles on one-line scanning of the camera.

### Embodiment 3

Rotation of light realized through rotation of reflector assembly:

The point light source rotating mechanism comprises: one rotational structure or two rotational structures;

Each rotational structure comprises a rotating motor with an encoder, a rotating disk, a point laser and a reflector assembly; the reflector assembly is arranged on the rotating disk; the rotating motor with an encoder drives the rotating disk to rotate and then drives the reflector assembly to rotate; the point laser is located on the extension line of the rotating shaft, and emergent lasers are incident on the reflector assembly; and when the reflector assembly rotates, the rotation speed of the emergent lasers is ensured to be consistent with the scanning speed of the image sensor mechanism, the phase is synchronized, and a region illuminated by lasers is in the region corresponding to the exposure line of the rolling shutter door of the image sensor mechanism.

When the point light source rotating mechanism comprises two rotational structures, the two rotational structures are arranged up and down along the same rotating shaft; in the first rotational structure and the second rotational structure, the respective rotating disks rotate in the opposite directions, and the respective reflector assemblies are arranged in the opposite positions.

The structure realizes the rotation of light through the rotation of the reflector assembly, which can reduce the number of lasers; and double-line scanning of a single laser can be realized, one laser can realize 360° scanning, and the assembly structure is simple.

In the embodiment of the present disclosure, the rotating motor with an encoder, the rotating disk and the driving relation are components available in the market, which will not be repeated here.

The image sensor mechanism comprises one or a plurality of cameras; the line scanning direction of the camera is consistent with the laser scanning direction, and the camera is arranged at a certain distance from the laser; and when a plurality of cameras are used, the cameras are arranged along the extension line of the rotating shaft in the circumferential direction.

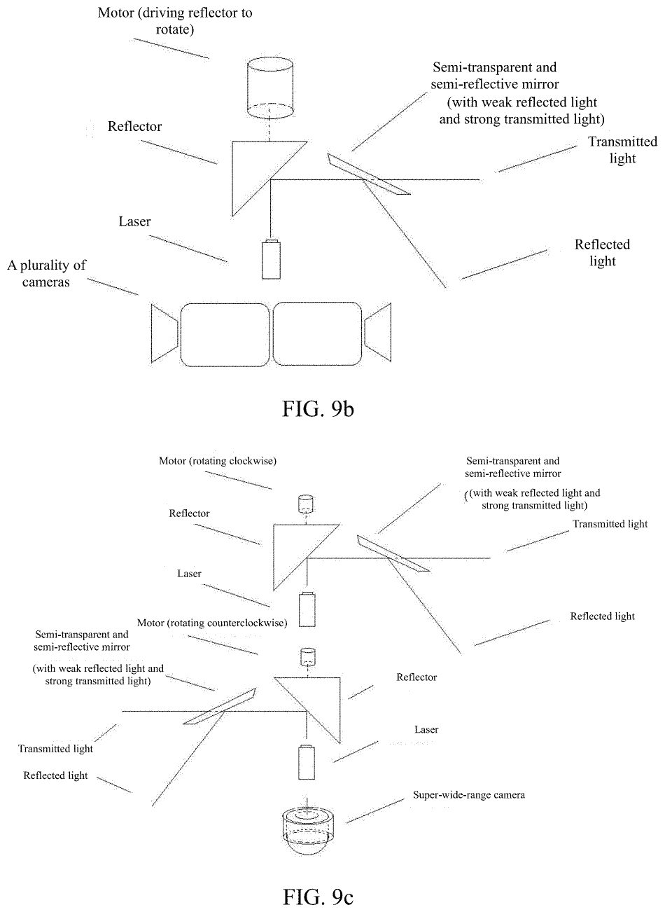

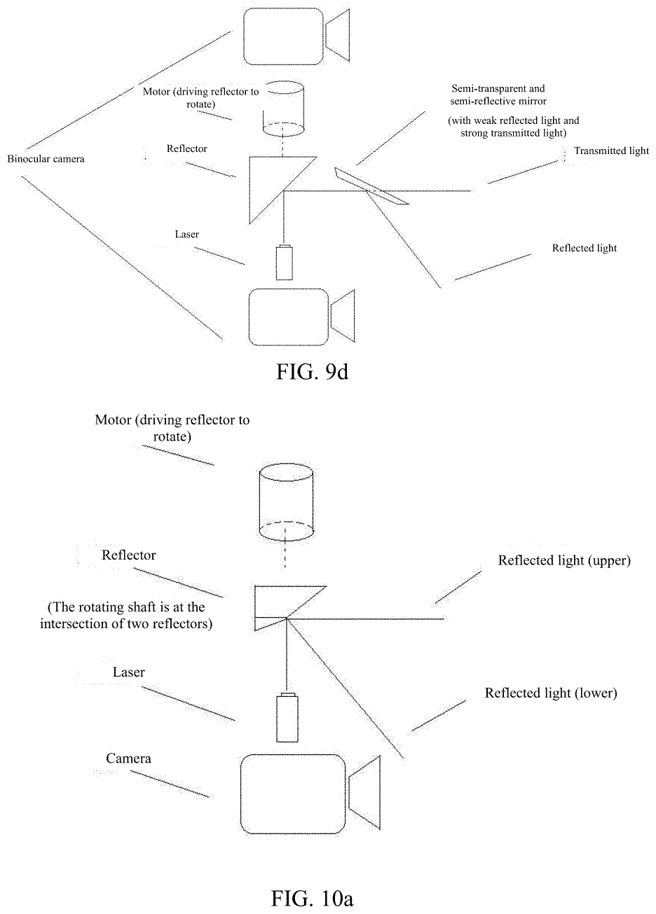

As shown in FIG. 9a, the image sensor mechanism is composed of one camera;

As shown in FIG. 9b, the image sensor mechanism is composed of a plurality of cameras which are arranged along the extension line of the rotating shaft in the circumferential direction;

As shown in FIG. 9c, the image sensor mechanism can be composed of a super-wide-range camera.

Of course, as shown in FIG. 9d, the image sensor mechanism also can be composed of a binocular camera which is used for scanning ranging synchronously with the laser and is coaxial with the rotating shaft.

As shown in FIG. 9a-FIG. 9d, the reflector assembly in the figures comprises a triangular reflector and a semi-transparent and semi-reflective mirror; the triangular reflector has a shape of right-angled triangle; during arrangement, one right-angle edge is parallel to the horizontal line, and the other right-angle edge is parallel to the vertical line; and the semi-transparent and semi-reflective mirror is arranged obliquely and is close to one side of the triangular reflector, and the included angle between the oblique semi-transparent and semi-reflective mirror and the horizontal line is an acute angle.

Emergent lasers of the point laser are incident on the center of the bevel edge of the triangular reflector and then are reflected into the center of the semi-transparent and semi-reflective mirror and split into two light beams: one beam is transmitted light, and the other beam is reflected light; and the transmitted light is strong, and the reflected light is weak. The two light beams are initially hit on a field of view (FOV) corresponding to the pixel of the first line of the image sensor mechanism, and the rotation speed of the two light beams is consistent with the line scanning speed of the image sensor mechanism, so as to realize that the lasers are always irradiated on the FOV corresponding to the exposure line of the image sensor mechanism.

The working principle is as follows: a laser point is reflected on the semi-transparent and semi-reflective mirror by the reflector and split into two laser points by the semi-transparent and semi-reflective mirror. When the camera starts to expose, the two laser points are hit on the FOV corresponding to the pixel of the first line of the camera, the rotation speed of the laser points is kept consistent with the line scanning speed of the camera, and the phase is synchronized. The motor drives the reflector to rotate so that point lasers form a line shape, and then form an upper line and a lower line when passing through the semi-transparent and semi-reflective mirror, which can be distinguished based on the positions of the laser points on the sensor according to the keyhole model of the camera. The accurate distance value can be obtained by triangulation ranging according to the relative position after being scanned by the camera.

For example, as shown in FIG. 9a, when the laser radar is applied to an intelligent agent with a fixed motion track, then one camera, one laser and one reflector assembly can be used to realize double-line scanning of a single laser so as to meet the needs of ranging.

As shown in FIG. 9b, when the laser radar is applied to an intelligent agent (such as sweeping robot) without a planned path, a plurality of cameras, one laser and one reflector assembly can be used to achieve accurate ranging of the surrounding objects.

As shown in FIG. 9c, for example, two rotational structures and a super-wide-range camera are used to realize a wider range of accurate ranging.

As shown in FIG. 9d, for example, one rotational structure and a binocular camera can be used to carry out distance testing synchronously with the laser of the point light source, which can effectively prevent the ranging error caused by rotation jitter of the laser; and the stability of the system can be improved by correction of the ranging error, the requirement for the precision of the system structure is lower than that for a monocular camera, and one-line and multi-line scanning ranging can be realized easily.

### Embodiment 4

It is different from embodiment 3 in that: the reflector assembly comprises two reflectors combined together. Compared with the structure in embodiment 3, the space is small, and the requirement for the alignment precision of the rotating shaft is high.

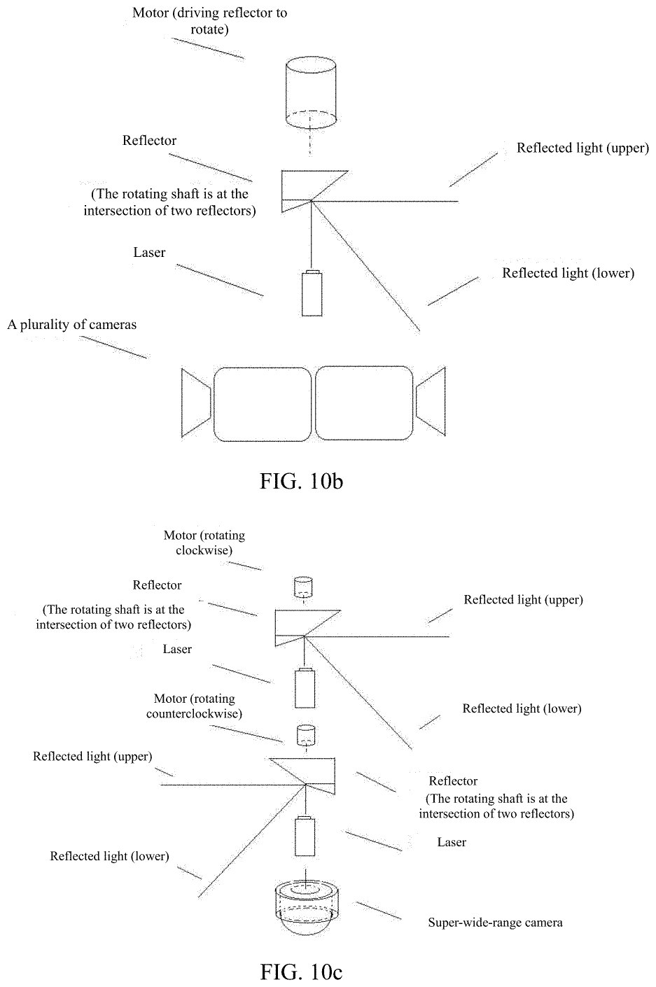

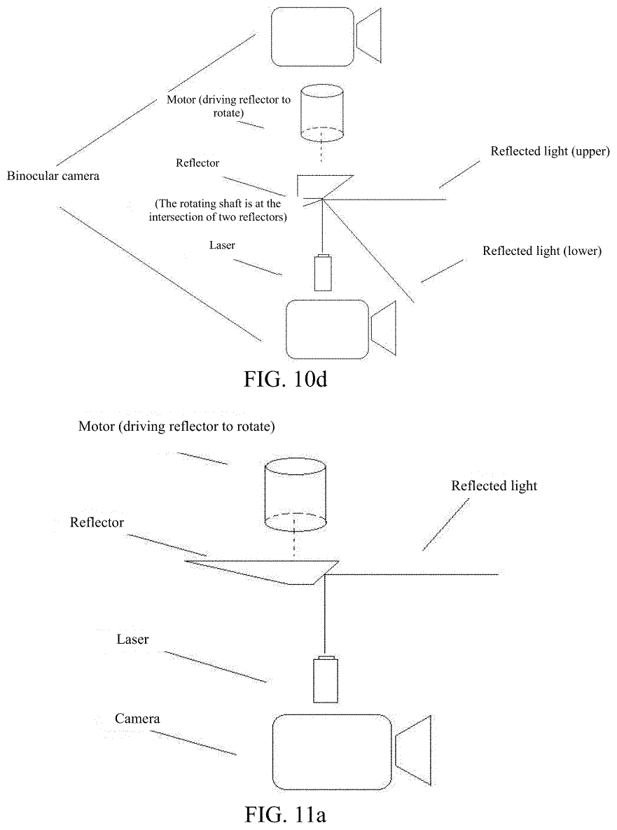

As shown in FIG. 10a, the image sensor mechanism is composed of one camera which is located on the extension line of the rotating shaft;

As shown in FIG. 10b, the image sensor mechanism is composed of a plurality of cameras which are arranged along the extension line of the rotating shaft in the circumferential direction;

As shown in FIG. 10c, two rotational structures are adopted, and the image sensor mechanism is composed of a super-wide-range camera which is arranged along the extension line of the rotating shaft;

As shown in FIG. 10d, one rotational structure is adopted, and the image sensor mechanism is composed of a binocular camera with two lenses respectively arranged along the extension line of the rotating shaft and located on both sides of the laser. The stability of the test system can be improved, the binocular camera and the laser are used for synchronous scanning ranging, the camera is coaxial with the rotating shaft, which can be arranged on both sides or one side of the laser, and the measurement of different FOVs can be realized by changing the number of the binocular cameras.

As shown in FIG. 10a-FIG. 10d, the reflector assembly in the figures comprises a right-angled trapezoidal reflector and a right-angled triangular reflector; during arrangement, the longer of two parallel edges of the right-angled trapezoidal reflector is as long as one right-angle edge of the right-angled triangular reflector; the two edges of the same length are fitted together and are parallel to the horizontal line; emergent lasers of the point laser are incident on the intersection of the two reflectors, which is also the intersection of the two bevel edges, and split into two light beams; one beam is upper reflected light, and the other beam is lower reflected light; the intersection is on the rotating shaft; and the two light beams are hit on a field of view (FOV) corresponding to the pixel of the first line of the image sensor mechanism, and the rotation speed of the two light beams is consistent with the line scanning speed of the image sensor mechanism.

That is: the initial positions of the two light beams are hit on a FOV corresponding to the pixel of the first line of the image sensor mechanism, and the rotating motor drives the reflector assembly to rotate so that the rotation speed of the two light beams is consistent with the line scanning speed of the image sensor mechanism, so as to realize that the lasers are always irradiated on the FOV corresponding to the exposure line of the image sensor mechanism.

The working principle is as follows: the laser point is hit on the intersection of the two reflectors and split into two laser points. When the camera starts to expose, the two laser points are hit on the FOV corresponding to the pixel of the first line of the camera, the rotation speed of the laser points is kept consistent with the line scanning speed of the camera, and the phase is synchronized. The motor drives the reflector to rotate so that point lasers form a line shape, and then form an upper line and a lower line when being hit on the intersection of the two reflectors, which can be distinguished based on the positions of the laser points on the sensor according to the keyhole model of the camera. The accurate distance value can be obtained by triangulation ranging according to the relative position after being scanned by the camera.

For example, when the laser radar is applied to an intelligent agent with a fixed motion track, then one camera, one laser and two reflectors combined together can be used to meet the needs of ranging. The two reflectors combined together can effectively reduce the volume of the laser radar in the horizontal direction and provide conditions for the design space of other components.

### Embodiment 5

It is different from embodiment 3 in that: the reflector assembly is a multi-faced prismatic reflector, for example, a prismatic reflector with multiple bevel edges of different slopes; and one or a plurality of point laser sources are used. A single reflector is adopted to realize double-line or multi-line scanning of a single laser. The structure is simple, multi-angle scanning can be realized by a single light source, and the requirement for the alignment precision of the rotating shaft is low, but multi-line switching is carried out during each period of rotation, which sacrifices the frame rate.

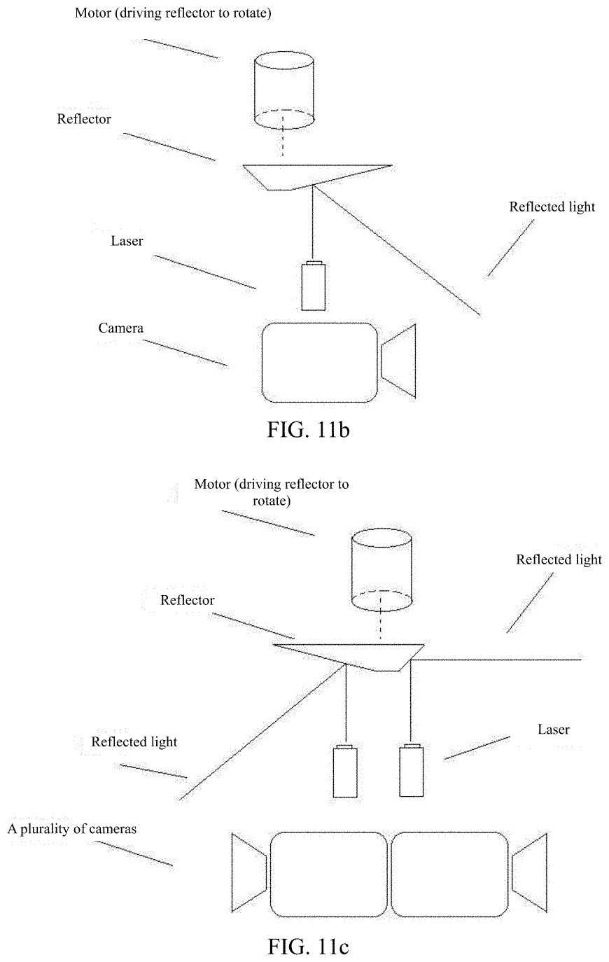

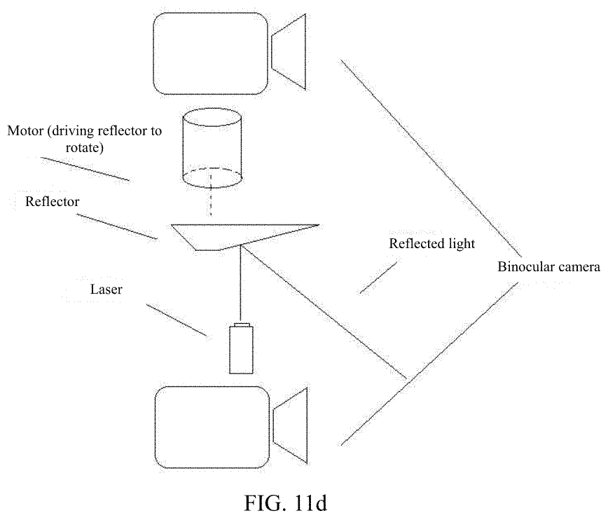

When the point light source is composed of one point laser, as shown in FIG. 11a, FIG. 11b and FIG. 11c, one point laser is located on one side of the extension line of the rotating shaft; and when the point light source is composed of a plurality of point lasers, the point lasers are arranged along the extension line of the rotating shaft in the circumferential direction;

The multi-faced prismatic reflector is arranged on the rotating disk; the rotating motor with an encoder drives the rotating disk to rotate and then drives the multi-faced prismatic reflector to rotate; and the lasers are irradiated on the reflectors with different angles, thus obtaining emergent lasers at different angles;

The rotation speed of the two alternating reflected light beams is consistent with the scanning speed of the image sensor mechanism, the phase is synchronized, and a region illuminated by lasers is in the region corresponding to the exposure line of the rolling shutter door of the image sensor mechanism.

As shown in FIG. 11a, the image sensor mechanism is composed of one camera which is located on the extension line of the rotating shaft; the point laser of the laser radar emits on one bevel edge of the reflector; and as shown in FIG. 11b, the point laser of the laser radar emits on the other bevel edge of the reflector;

As shown in FIG. 11c, the image sensor mechanism can be composed of a plurality of cameras which are uniformly arranged along the extension line of the rotating shaft in the circumferential direction;

As shown in FIG. 11d, the image sensor mechanism can be composed of a binocular camera, which can improve the stability of the test system, the binocular camera and the laser are used for synchronous scanning ranging, and the camera is coaxial with the rotating shaft of the reflector, which can be arranged on both sides or one side of the laser; and the measurement of different FOVs is realized by changing the number of the binocular cameras.

As shown in FIG. 11a-FIG. 11d, the reflector assembly in the figures is provided with a prismatic reflector with two bevel edges of different slopes; and during arrangement, two parallel edges are parallel to the horizontal line.

The working principle is as follows: as shown in FIG. 11a, the laser point is hit on the surface with high slope of the reflector to obtain an upper reflected light beam; and the motor drives the reflector to rotate, and as shown in FIG. 11b, the laser point is hit on the surface with low slope of the reflector to obtain a lower reflected light beam. When the camera starts to expose, the laser point is hit on the FOV corresponding to the pixel of the first line of the camera, the rotation speed of the laser point is kept consistent with the line scanning speed of the camera, and the phase is synchronized. The motor drives the reflector to rotate so that point lasers form a line shape, multiple reflected light beams alternate and can project light at different angles, and after being scanned by the camera, the distance values of different light angles can be obtained by triangulation ranging according to the relative positions based on the angle of lasers corresponding to the current imaging frame of the camera. Therefore, the result of time-sharing and multi-line measurement is realized.

The laser radars of the above five embodiments can be selected according to specific application scenarios. The laser radar of the present invention uses low-power laser points instead of line lasers to realize laser safety power and achieve high-precision ranging. In the prior art, the point laser scanning that is eye-safe is only at 2300 Hz and has an angle resolution of only 1°, while the present invention can greatly improve the precision by combining the advantages of line lasers, for example, a camera with the FOV of 120°, corresponding to the common resolution of 1600×1200 (ov2640) at 15 hz, sensor, can easily achieve an angle resolution of 120/1200=0.1°, and the rate of point of emergence can achieve 15*1200=18,000. Meanwhile, 360° scanning can be realized by the design of a plurality of cameras or a special system (such as fisheye lens). In addition, the application of multi-line scanning can also be realized by multi-laser projection direction. For example, the functions of an LDS radar+a laser sensor along the wall line+a cliff sensor can be replaced on a sweeping robot, so the cost is lower, the system is simpler, and the equipment is more intelligent. The urgent needs of the market at the current stage are met, and a better solution is provided for civil laser ranging products in the market.

Based on the same inventive concept, the embodiments of the present invention also provide a detection method for a laser radar for synchronous scanning of line exposure and point lasers of a rolling shutter door. Since the principle of the method for solving problems is similar to that of the laser radar for synchronous scanning of line exposure and point lasers of a rolling shutter door, the implementation of the method can be referred to that of the laser radar, which will not be repeated again.

The detection method for a laser radar for synchronous scanning of line exposure and point lasers of a rolling shutter door provided by the embodiments of the present invention uses the laser radar for synchronous scanning of line exposure and point lasers of a rolling shutter door of any of the above embodiments to realize ranging of the target object. The method comprises:

(1) Controlling the rotation speed of the point light source rotating mechanism to be consistent with the scanning speed of the image sensor mechanism and the phase to be synchronized, and keeping a region illuminated by lasers in the region corresponding to the exposure line of the rolling shutter door of the image sensor mechanism;

(2) According to the emission angle and baseline distance of lasers in the point light source rotating mechanism, obtaining the distance from the target object by triangulation ranging after scanning with the image sensor mechanism.

Compared with the prior art, the present invention adopts the low-power single point light source to realize one-line and multi-line scanning, and the solution has wide applicability and high human eye safety; and the distance from the target object is obtained by triangulation ranging, which is convenient, efficient and accurate.

Obviously, those skilled in the art could implement various modifications to and variations of the present invention without departing from the spirit and scope of the present invention. So, the present invention is intended to include the modifications and variations if the amendments and variations of the present invention belong to claims of the present invention and the equivalent technical scope.

What is claimed is:

1. A laser radar for synchronous scanning of line exposure and point lasers of a rolling shutter door, comprising: a point light source rotating mechanism and an image sensor mechanism;
the rotation speed of the point light source rotating mechanism is consistent with the scanning speed of the image sensor mechanism, the phase is synchronized, and a region illuminated by lasers is in the region corresponding to the exposure line of the rolling shutter door of the image sensor mechanism.

2. The laser radar for synchronous scanning of line exposure and point lasers of a rolling shutter door according to claim 1, wherein the point light source rotating mechanism comprises a rotating motor with an encoder, a rotating disk, and one or a plurality of point lasers;
when one point laser is used, the laser is arranged at a preset distance from the image sensor mechanism, and the scanning direction is consistent; and when a plurality of point lasers are used, the point lasers are arranged along the rotating disk in the circumferential direction;
the rotating motor with an encoder drives the rotating disk to rotate and then drives the point laser to rotate;
the rotation speed of the point laser is consistent with the scanning speed of the image sensor mechanism, the phase is synchronized, and a region illuminated by lasers is in the region corresponding to the exposure line of the rolling shutter door of the image sensor mechanism.

3. The laser radar for synchronous scanning of line exposure and point lasers of a rolling shutter door according to claim 1, wherein the image sensor mechanism comprises one or a plurality of cameras;
when a plurality of cameras are used, the cameras are arranged along the extension line of the rotating shaft in the circumferential direction; and when one camera is used, the line scanning direction of the camera is consistent with the laser scanning direction of the point light source rotating mechanism, and the camera is arranged at a preset distance from the point light source rotating mechanism.

4. The laser radar for synchronous scanning of line exposure and point lasers of a rolling shutter door according to claim 1, wherein the image sensor mechanism is composed of a binocular camera.

5. The laser radar for synchronous scanning of line exposure and point lasers of a rolling shutter door according to claim 3, wherein the rotating disk comprises an upper rotating disk and a lower rotating disk; and the upper rotating disk and the lower rotating disk are respectively provided with an equal number of point lasers which are arranged along the respective rotating disk in the circumferential direction and in the positions corresponding vertically;
the upper rotating disk and the lower rotating disk rotate in the opposite directions so that the scanning direction of the laser mounted on the point light source rotating mechanism is corresponding to the exposure line projected by laser spots;
the image sensor mechanism is composed of a plurality of cameras or one wide-angle camera; and when the image sensor mechanism is composed of a plurality of cameras, the cameras are arranged along the extension line of the rotating shaft in the circumferential direction;
the upper rotating disk and the lower rotating disk rotate in the opposite directions to drive the point laser to rotate into a line shape and corresponding to the top-down exposure sequence of the rolling shutter door.

6. The laser radar for synchronous scanning of line exposure and point lasers of a rolling shutter door according to claim 3, wherein the point light source rotating mechanism comprises: one rotational structure or two rotational structures;
each rotational structure comprises a rotating motor with an encoder, a rotating disk, a point laser and a reflector assembly;
the reflector assembly is arranged on the rotating disk; the rotating motor with an encoder drives the rotating disk to rotate and then drives the reflector assembly to rotate; and emergent lasers of the point laser are incident on the reflector assembly;
when the reflector assembly rotates, the rotation speed of the emergent lasers is ensured to be consistent with the scanning speed of the image sensor mechanism, and a region illuminated by lasers is in the region corresponding to the exposure line of the rolling shutter door of the image sensor mechanism;
when the point light source rotating mechanism comprises two rotational structures, the two rotational structures are arranged up and down along the same rotating shaft; and in the first rotational structure and the second rotational structure, the respective rotating disks rotate in the opposite directions, and the respective reflector assemblies are arranged in the opposite positions.

7. The laser radar for synchronous scanning of line exposure and point lasers of a rolling shutter door according to claim 6, wherein the reflector assembly comprises a triangular reflector and a semi-transparent and semi-reflective mirror;
emergent lasers of the point laser are incident on the triangular reflector, and then are reflected into the semi-transparent and semi-reflective mirror and split into two light beams: one beam is transmitted light, and the other beam is reflected light;
the initial positions of the two light beams are hit on a field of view (FOV) corresponding to the pixel of the first line of the image sensor mechanism, and the rotating motor drives the reflector assembly to rotate so that the rotation speed of the two light beams is consistent with the line scanning speed of the image sensor mechanism, so as to realize that the lasers are always irradiated on the FOV corresponding to the exposure line of the image sensor mechanism.

8. The laser radar for synchronous scanning of line exposure and point lasers of a rolling shutter door according to claim 6, wherein the reflector assembly comprises two reflectors combined together;
emergent lasers of the point laser are incident on the intersection of the two reflectors, and split into two light beams: one beam is upper reflected light, and the other beam is lower reflected light; and the intersection is on the rotating shaft;
the initial positions of the two light beams are hit on a field of view (FOV) corresponding to the pixel of the first line of the image sensor mechanism, and the rotating motor drives the reflector assembly to rotate so that the rotation speed of the two light beams is consistent with the line scanning speed of the image sensor mechanism, so as to realize that the lasers are always irradiated the FOV corresponding to the exposure line of the image sensor mechanism.

9. The laser radar for synchronous scanning of line exposure and point lasers of a rolling shutter door according to claim 3, wherein the point light source rotating mechanism comprises a rotating motor with an encoder, a rotating disk, a point laser source and a multi-faced prismatic reflector;
when the point laser source is composed of one point laser, the laser is arranged at a preset distance from the image sensor mechanism, and the scanning direction is consistent; and when the point laser source is composed of a plurality of point lasers, the point lasers are arranged along the extension line of the rotating shaft in the circumferential direction;
the multi-faced prismatic reflector is arranged on the rotating disk; the rotating motor with an encoder drives the rotating disk to rotate and then drives the multi-faced prismatic reflector to rotate; and when the multi-faced prismatic reflector rotates, the direction of light emission will change due to the change of the included angle between the reflecting surface and the lasers, thus obtaining multiple reflected lasers with different angles of light emission;
the rotation speed of the multiple alternating reflected lasers is consistent with the scanning speed of the image sensor mechanism, and a region illuminated by lasers is in the region corresponding to the exposure line of the rolling shutter door of the image sensor mechanism.

10. The laser radar for synchronous scanning of line exposure and point lasers of a rolling shutter door according to claim 4, wherein the point light source rotating mechanism comprises a rotating motor with an encoder, a rotating disk, a point laser source and a multi-faced prismatic reflector;
when the point laser source is composed of one point laser, the laser is arranged at a preset distance from the image sensor mechanism, and the scanning direction is consistent; and when the point laser source is composed of a plurality of point lasers, the point lasers are arranged along the extension line of the rotating shaft in the circumferential direction;
the multi-faced prismatic reflector is arranged on the rotating disk; the rotating motor with an encoder drives the rotating disk to rotate and then drives the multi-faced prismatic reflector to rotate; and when the multi-faced prismatic reflector rotates, the direction of light emission will change due to the change of the included angle between the reflecting surface and the lasers, thus obtaining multiple reflected lasers with different angles of light emission;
the rotation speed of the multiple alternating reflected lasers is consistent with the scanning speed of the image sensor mechanism, and a region illuminated by lasers is in the region corresponding to the exposure line of the rolling shutter door of the image sensor mechanism.

11. A detection method for a laser radar for synchronous scanning of line exposure and point lasers of a rolling shutter door, using the laser radar for synchronous scanning of line exposure and point lasers of a rolling shutter door of claim 1 to realize ranging of a target object, and comprising:
S1 controlling the rotation speed of the point light source rotating mechanism to be consistent with the scanning speed of the image sensor mechanism and the phase to be synchronized, and keeping a region illuminated by lasers in the region corresponding to the exposure line of the rolling shutter door of the image sensor mechanism;
S2 according to the emission angle and baseline distance of lasers in the point light source rotating mechanism, obtaining the distance from the target object by triangulation ranging after scanning with the image sensor mechanism.
